(19) United States
(12) Patent Application Publication
(10) Pub. No.: US 2011/0001020 A1
(43) Pub. Date: Jan. 6, 2011

(54) QUAD TILT ROTOR AERIAL VEHICLE WITH STOPPABLE ROTORS

(76) Inventor: Pavol Forgac, Bratislava (SK)

Correspondence Address: PAVOL FORGAC / AVICAR INTERNATIONAL, INC., N.S. TRNAVSKEHO 1, BRATISLAVA, 84101, SK

(21) Appl. No.: 12/829,423

(22) Filed: Jul. 2, 2010

Related U.S. Application Data
(60) Provisional application No. 61/222,741, filed on Jul. 2, 2009.

(51) Int. Cl. B64C 27/26

(52) U.S. Cl. 244/7 A

(57) ABSTRACT

The disclosed invention consists of several improvements to well known Quad Tilt-Rotor (QTR) aircraft. The first is that during a wing-borne flight, one pair of tilt-rotors, which can be substantially larger than the other pair, is feathered and stopped. This can promote vehicle aerodynamic efficiency and can be utilized to increase vehicle speed. Second is that the wings are not attached to the fuselage at a fixed angle of incidence like on conventional QTR aircraft, but can also be tilted in respect to the fuselage independently of the tilt-rotors. Furthermore, each rotor and each wing can be tilted with respect to fuselage to any tilt-angle without limit, which gives the vehicle unprecedented ability to position the fuselage in any attitude in respect to the vehicle direction of flight.

### CROSS-REFERENCE TO RELATED APPLICATIONS

This Application is a non-provisional application of provisional (35 USC 119(e)) application 61/222,741 filed in the United States on Jul. 2, 2009, the entire disclosure of which is incorporated by reference herein.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

Tilt-rotor aerial vehicles are well known and used both in military (e.g., Bell/Boeing V-22 Osprey) and in civilian applications (Bell Augusta BA-609). As is known to those skilled in design of such vehicles, they suffer from various deficiencies, such as aeroelastic instability limiting their maximum speed, poor hover efficiency, excessive vibrations and larger noise levels due to large prop-rotors.

To eliminate or reduce these deficiencies, several approaches have been considered by prior art. One is stopping the rotors in forward flight and propelling the vehicle in such flight by other means, usually by jet engines fixed with the thrust vector substantially parallel to the direction of flight, as have been described in the prior art (e.g., US patent documents 20100072325, U.S. Pat. Nos. 5,085,315, 3,592,412, 3,404,852). Aircraft described therein are designed to operate in cruise mode such that the blades of stopped tilt-rotors are folded to minimize the drag.

Folding the blades results in rotor complexity. Thus, another prior art (U.S. Pat. No. 4,979,698) uses unfolded rotors that are stowed behind the fixed wings and feathered to provide added lift while the aircraft is wing borne. As the tilt-rotors in this case are not powered, they cannot be used for Vertical Take-Off and Landing (VTOL), however; this design is intended to give a high speed jet propelled aircraft only a Short Take-Off and Landing (STOL) capability.

Another prior art (U.S. Pat. No. 3,797,783) discloses aircraft with a pair of wing tip mounted tilt-rotors (rotary wings) that are driven for VTOL and tilted, feathered and stowed in forward flight such that the feathered rotary wings form an operative extension of the fixed wing.

Yet another peculiar group of rotorcraft with some commonality to the disclosed invention are those with forward (canard) tilt-rotors/tilt-wings and stoppable main VTOL rotary wings (e.g., patent documents U.S. Pat. No. 7,665,688 or WO/2007/014531), but the main rotary wings in these designs are not tiltable.

Finally, well known are also Quad Tilt-Rotor (QTR) or quad tilt-wing aircraft (e.g., US patent documents D453317, U.S. Pat. No. 7,004,426, 20050230519, U.S. Pat. No. 4,982,914), although no such designs with rotors that are meant to be stopped in flight are known in prior art.

### BRIEF SUMMARY

The present invention is an Quad Tilt-Rotor (QTR) aerial vehicle with one pair of tilt-rotors stoppable when in high speed forward flight.

During VTOL and hover, all four rotors are tilted substantially vertically to provide lift. In the preferred embodiment, the larger (main) rotors provide during the rotor-borne flight virtually all the lift while the smaller rotors (propellers) serve mainly for the vehicle (fuselage) attitude control. Thus, the vehicle can be controlled only by the tilt and collective pitch of main rotors and propellers, eliminating the need for cyclic pitch control.

The vehicle is equipped also with two pairs of airfoil section wings substantially normal to fuselage (same as on other QTR aircraft). At sufficiently high vehicle airspeed, these wings provide the vehicle flight sustainment lift, upon which the tilt-rotors can be tilted from substantially vertical to substantially horizontal position and the main rotors can be feathered and stopped. Having only smaller propellers provide propulsion during high speed flight eliminates aeroelastic instability problem of conventional tilt rotor aircraft and stopped main rotor can increase the vehicle aerodynamic efficiency.

The wings in the disclosed invention can be attached to the fuselage in fixed position like on conventional QTR aircraft. In the preferred embodiment, however, the wings are attached such that they are also tiltable along the same axis as their tip rotors but independently of the rotors, which further increases vehicle maneuverability and fuselage attitude control. In the preferred embodiment, each tilt rotor and each wing can be tilted to any angle in respect to fuselage without limit, giving the vehicle unprecedented fuselage attitude control in respect to flight direction (vector), which can be utilized, for instance, for aiming fuselage mounted gun.

### BRIEF DESCRIPTION OF THE DRAWINGS

FIG. 1 shows an exemplary embodiment of an unmanned aerial vehicle in a fixed wing forward flight with rotors in horizontal position (after being tilted from vertical position shown transparent).

FIGS. 2A, 2B and 2C show the exemplary aerial vehicle in a rotary wing configuration.

FIGS. 3A, 3B and 3C show the exemplary aerial vehicle in a fixed wing flight configuration.

FIG. 4 shows the side view of the exemplary vehicle with the rotors in vertical position. It shows that the rotors and wings (not shown) can tilt to any position in respect to fuselage, or that the fuselage can be positioned at any attitude in respect to rotors/wings.

FIG. 5 shows the fuselage of the exemplary vehicle with optional payload such as cameras, automatic rifle and laser target designator.

### DETAILED DESCRIPTION

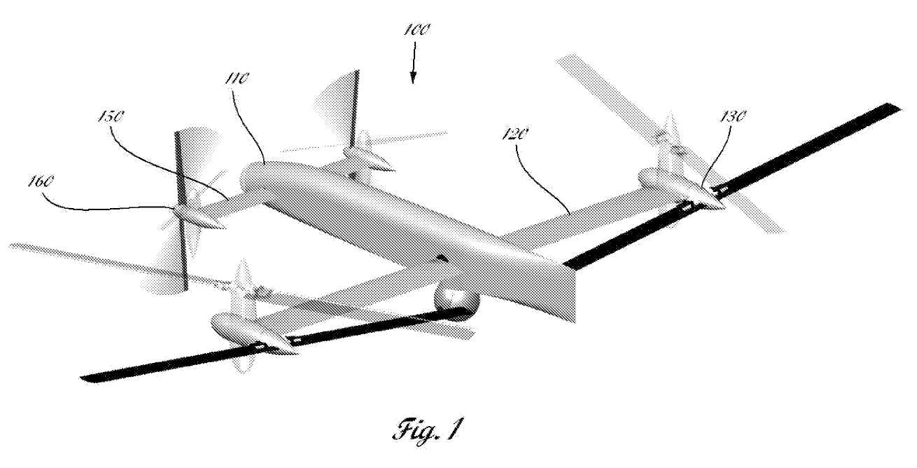

The exemplary aerial vehicle illustrated in FIGS. 1-3 is capable of vertical takeoff and landing, hover, and low speed flight with agile maneuvering while operating as a rotary wing aircraft, and efficient high-speed flight when operating as a fixed wing aircraft.

The vehicle 100 consists of a fuselage 110 with a pair of main wings 120 and tip mounted main rotors 130 attached to the central or aft section of the fuselage. To the front section of the fuselage is attached a pair of elevators 150 and propellers 160. In the preferred embodiment shown in FIGS. 1-4, the main wings 120 and main rotors 130 are significantly larger than the elevators 150 and propellers 160. However, rotors of equal size can be employed in other embodiments of the disclosed invention too.

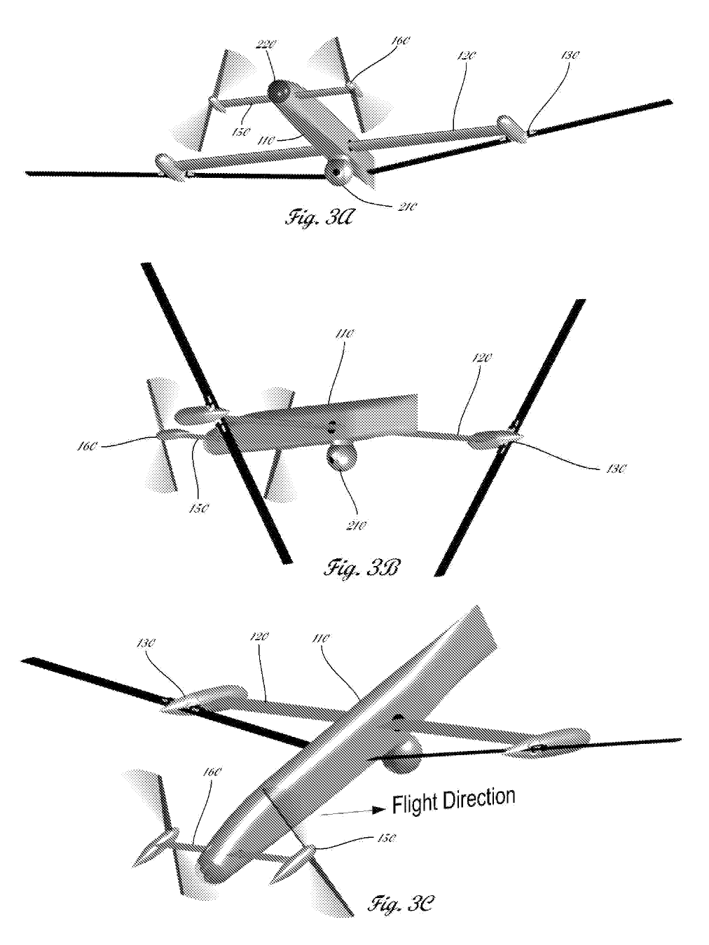

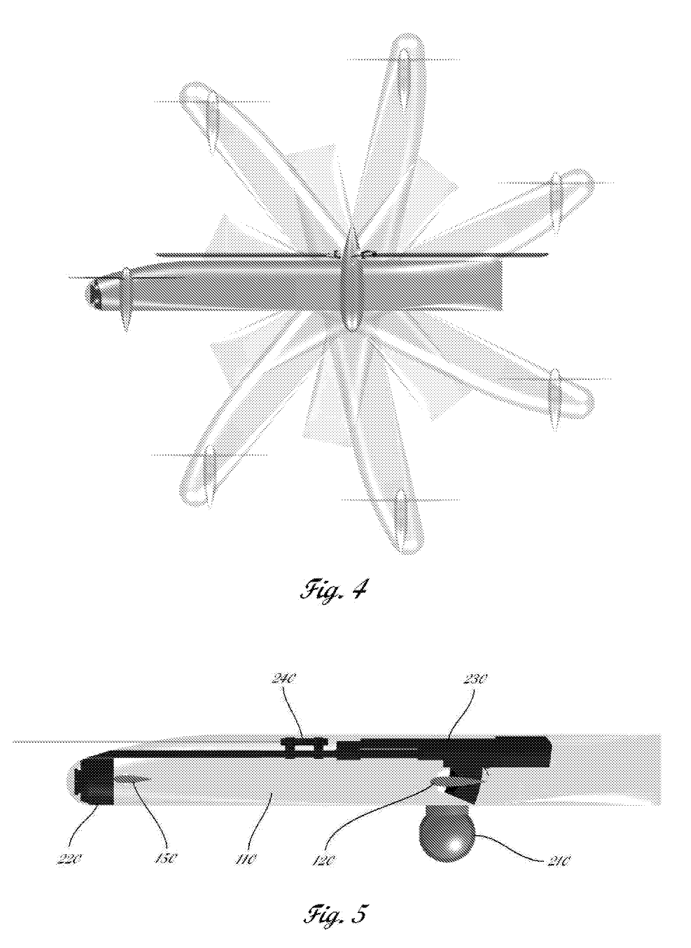

The main rotors 130 and propellers 160 can be tilted from substantially vertical position for rotor-borne flight to substantially horizontal position for high speed wing-borne flight, as shown in FIG. 1. During wing-borne flight the propellers 160 serve for vehicle propulsion. Unlike conventional Quad Tilt-Rotor (QTR) aircraft, however, the main rotors 130 do not serve for propulsion during wing borne flight. Thus, they can be feathered and stopped in position to provide additional lift, as shown in FIGS. 1 and 3A, or in some other advantageous position, for example in position shown in FIG. 3B.

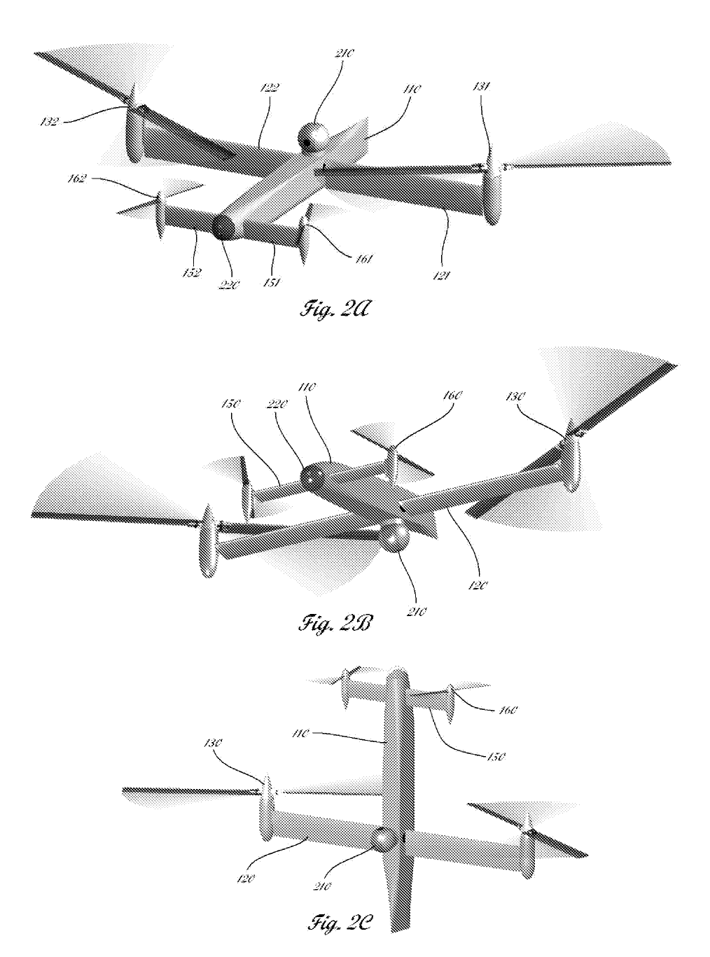

During the rotor-borne flight shown in FIGS. 2A, 2B and 2C, the main rotors of the preferred embodiment vehicle provide nearly all the lift, while propellers serve mainly for the vehicle (fuselage) attitude control. The vehicle rotor-borne flight can be thus controlled only by the tilt and collective pitch of the main rotors and propellers, eliminating the need for cyclic pitch control. However, equipping the main rotors also with cyclic pitch control can further increase the vehicle maneuverability.

In the preferred embodiment vehicle, the main wings 120 and rotors 130 are significantly larger than the elevators 150 and propellers 160. This is to decrease the propellers disc area and to eliminate aeroelastic instability caused by large prop-rotors. However, wings, elevators and rotors of similar or equal size, as on conventional QTR aircraft, can be employed in other embodiments of the disclosed invention too.

Due to their larger size, the wings 120 with main rotors 130 are in the preferred embodiment attached to the fuselage 110 longitudinally closer to the vehicle Center of Gravity (CG), with elevators 150 and propellers 160 being attached longitudinally at larger distance from the CG. If main rotors and propellers with smaller difference in their respective sizes are used, the difference in their respective longitudinal distances from the CG should be also smaller.

The left main rotor 131 rotates during the rotor-borne flight in opposite direction than right main rotor 132. The left propeller 162 and right propeller 162 also rotate in opposite direction at all flight conditions, same as on conventional QTR.

Unlike on conventional QTR aircraft, in the preferred embodiment vehicle the wings 120 and elevators 150 can also tilt in respect to fuselage. For example, FIG. 2A shows the vehicle as it would normally sit on the ground, with wings and elevators in vertical position for added stiffness.

In the preferred embodiment, each wing 121 and 122, each main rotor 131 and 132, each elevator 151 and 152, and each propeller 161 and 162 can be independently tilted around its tilting axis substantially normal to fuselage to any angle without limit. This enables the fuselage to be pointed in any attitude in respect to the vehicle flight direction, as shown in FIGS. 3C and 4. It also enables the vehicle of Vertical Take-Off and Landing (VTOL) in other than horizontal position; for instance, FIG. 2C shows VTOL in vertical position.

Capability of each rotor/propeller and each wing/elevator to be tilted at any angle in respect to the fuselage enable the vehicle to fly or land “belly-up”, as shown in FIG. 2A. When the vehicle is equipped with the optional sensor turret 210 (housing electro-optical camera, for instance) mounted on the fuselage 110 close to vehicle center of gravity, it enables the vehicle to land with the turret above the fuselage. Thus the vehicle can serve as a sensor when “perched” in locations, such as rooftops, that might otherwise be inaccessible. During the normal flight, the vehicle turret would be positioned below the fuselage, as shown in FIGS. 2B, 3A, 3B and 3C, giving it better field of view of the ground below.

Thanks to the unlimited tilt angle of each wing and rotor, the vehicle fuselage can be pointed during both the rotor-borne and the wing-borne flight at directions other than the flight direction, as shown in FIGS. 3C and 4. If the vehicle is equipped, for instance, with an automatic rifle 230, nose (targeting) camera 220 and laser designator 240, as shown in FIG. 5, the fuselage can be pointed such as to track and shoot at a moving target while the vehicle moves ahead of target in the same direction as the target.

The invention has been described with reference to certain preferred embodiments thereof. It will be understood, however, that the invention is not limited to the preferred embodiments discussed above, and that modification and variations are possible within the scope of the appended claims.

What is claimed as new and desired to be protected by the United States patent is:

1. A convertible aerial vehicle having a fixed wing flight mode and a rotary wing flight mode, the aerial vehicle comprising: a fuselage; two pairs of airfoil section wings attached in tandem to said fuselage; four rotors, each rotor having a shaft and at least one airfoil section blade that can rotate in a plane normal to said shaft; said rotors tiltably arranged at the tips of said wings; means for rotary driving each of said rotors; means of disengaging said rotary driving means to rotors on one pair of said wings when in fixed wing flight mode; and means of feathering the blade(s) of the rotors with driving means disengaged during the fixed wing flight mode.

2. The aerial vehicle of claim 1, further including means for inhibiting rotation of said feathered rotors.

3. The aerial vehicle of claim 2, whereas blades of said rotors can be affixed in such position as to assist the wings in creation of lift.

4. The aerial vehicle of claim 1, having each rotor tiltable by at least 90 degrees from substantially vertical to substantially horizontal position.

5. The aerial vehicle of claim 1, having each rotor tiltable independently of the other rotors.

6. The aerial vehicle of claim 1, having wings tiltable together with their respective tip rotors.

7. The aerial vehicle of claim 1, having wings tiltable independently of their tip rotors.

8. The aerial vehicle of claim 1, having each rotor and each wing tiltable independently of the other rotors and wings and without angular limit in respect to the fuselage.

9. The aerial vehicle of claim 1, having at least one pair of tiltable wings, said wings being tiltable together with or independently of said wings tip rotors.

10. The aerial vehicle of claim 1, further including means for cyclic pitch control of blades on at least one pair of rotors.

11. The aerial vehicle of claim 1, having said rotors driven by at least one common motor(s) via mechanical powertrain, and having means to disengage one pair of rotors from said common motor(s).

12. The aerial vehicle of claim 1, having rotors on each pair of wings mechanically cross-connected and driven by independent motor(s), with said motors(s) being stopped with their respective rotor pair.

13. The aerial vehicle of claim 1, having mechanically not-cross connected driving motor(s) attached to each rotor, with each said motor(s) being stopped with its respective rotor.

14. The aerial vehicle of claim 1, having one pair of rotors and wings substantially larger than the other pair of rotors and wings.

15. The aerial vehicle of claim 1, having each rotor on one pair of wings rotate in opposite direction.

16. The aerial vehicle of claim 1, having each of non-feathering rotors substituted by one or more ducted fans, jet engines or other means of propulsion.

17. The aerial vehicle of claim 9, having each of non-feathering rotors substituted by one or more ducted fans, jet engines or other means of propulsion.

18. The aerial vehicle of claim 1, having each of non-feathering rotors together with the wings on which tips said rotors would be arranged substituted by one or more ducted fans, jet engines or other means of propulsion.
